(19) United States
(12) Patent Application Publication
(10) Pub. No.: US 2009/0111085 A1
(43) Pub. Date: Apr. 30, 2009

(54) PERSONALIZED TEXTBOOK SUGGESTION BASED ON TEST SCORES AND LINK STRUCTURES OF COVERED TOPICS

(76) Inventors: Raymond H. P. Rudy, Yokohama-shi (JP); Kazutaka Yamasaki, Tokyo (JP)

Correspondence Address: LAW OFFICE OF IDO TUCHMAN (YOR), ECM #72212, PO Box 4668, New York, NY, 10163-4668, US

(21) Appl. No.: 12/258,343

(22) Filed: Oct. 24, 2008

(30) Foreign Application Priority Data
Oct. 24, 2007 (JP) 2007-276943

(51) Int. Cl. G09B 7/04

(52) U.S. Cl. 434/353

(57) ABSTRACT

A teaching material selection method, a computer program and a teaching material selection device for selecting the set of most suitable teaching materials on the basis of learning assessment data on an examinee. Provided is a teaching material selection method allowing a computer to execute the steps of: calculating achievement of an examinee in an academic skill area on the basis of learning assessment data of the examinee and a difficulty level of the academic skill area; calculating importance of the academic skill area on the basis of the academic skill area interrelationship structure indicating an interrelationship between the achievement and the academic skill area; calculating a value of a teaching material on the basis of the importance of the academic skill area; and performing calculation for selecting a set of teaching materials on the basis of the value of the teaching materials.

### CROSS-REFERENCE TO RELATED APPLICATIONS

This application claims priority under 35 U.S.C. § 119 to Japan Patent Application No. 2007-276943 filed Oct. 24, 2007, the entire text of which is specifically incorporated by reference herein.

### BACKGROUND OF THE INVENTION

The present invention relates to an education support system utilizing a computer. More particularly, the present invention relates to a teaching material selection method for selecting the best combination of teaching materials on the basis of learning assessment data of an examinee, and also relates to a computer program and teaching material selection.

In the field of education, it has heretofore been difficult for teachers to select the best teaching materials on the basis of learning assessment data of examinees. The prior art concerning selection of the teaching materials are mainly classified as follows:

1) Method for explicitly specifying a topic and a teaching material according to rules and the like that depend on examinees scores;

2) Method for obtaining a combination of topics and teaching materials by use of mathematical programming; and

3) Method using the above two methods in combination.

Most of the prior art utilize characteristics of learning curriculums. Examples of the characteristics of the learning curriculums include: that learning curriculums of a particular grade in schools or private preparatory schools are constituted of multiple academic skill areas (hereinafter referred to as topics); and that the teaching materials used in the curriculum cover a certain topic or multiple topics.

Japanese Patent Application Publication Nos. 2005-241914, 2000-66572 and 2003-345908 (These documents are hereinafter referred to as Patent Documents 1, 2 and 3, respectively) and Hiroshi Abe: The Research on Learning Management System with Navigation Functions, Japan Advanced Institute Science and Technology, Hokuriku, master's thesis, March, 2003 (This document is hereinafter referred to as Non-patent Document 1) disclose techniques related to the above 1) method for explicitly specifying a topic and a teaching material according to rules and the like set by score. Patent Document 1 discloses a technique of providing teaching materials connected by class. Moreover, Non-patent Document 1 discloses a technique of providing a list of teaching materials prioritized on the basis of teaching material information and learning histories in the past. Patent Document 2 discloses a technique of: evaluating a score on the basis of all of the ability to solve test questions, improvement in score, and solving time; comparing the evaluated value with a preset threshold; and dynamically changing a level of a teaching material to be selected. Moreover, Patent Document 3 discloses a technique of: calculating a level of understanding on the basis of a score and a passing reference score; and selecting a teaching material corresponding to the calculated value which is lower than a preset threshold of the teaching material.

Toshihiko Takeuchi, Akiyuki Sakuma: Research on an Invoking System in Task-given-type Examinations, Journal of Japan Industrial Management Association, Vol. 53, No. 3, pp. 189 to 200, Aug. 15, 2002 (This document is hereinafter referred to as Non-patent Document 2) discloses a technique related to the above 2) method for obtaining a combination of a topic and a teaching material by use of mathematical programming. Specifically, Non-patent Document 2 discloses a technique for determining a combination of knowledge of new test questions, when the new test questions are added to existing test questions, so that the newly-formed test questions cover both the basics and applications of knowledge. The combination of the knowledge of the new test questions is determined so as to maximize an objective function whose variables represent the basics, the applications of knowledge and the ease of test question preparation, and whose constraints are the number of the new test questions and the number of the knowledge. In the determination of the combination of knowledge, an integer programming problem is formulated and a solution is obtained by use of a genetic algorithm.

Meanwhile, prior art related to a topic interrelationship structure include a PAGERANK (registered trademark) algorithm (see L. Page, S. Brin, R. Motwani, T. Winograd: The PageRank Citation Ranking: Bringing Order to the Web, Stanford Digital Library Technologies Project, 1998.) and its development (see T. H. Haveliwala: Topic-sensitive PageRank, Proc. of the 11th WWW Conference, 2002.) or the like (hereinafter collectively referred to as a PageRank method). Specifically, the PAGERANK algorithm is one of the main techniques for the Internet search. The algorithm or method described above is a method for setting an order of topics by use of an eigenvector corresponding to the maximum eigenvalue of an adjacency matrix determined by a structure of the equivalent (for example, a website on the Internet) of the topics.

The conventional technique related to the above method 1) enables selection of a suitable teaching material on the basis of information about scores and the like of examinees or the like. However, objects of selection are only teaching materials for topics that have score information and therefore, teaching materials of related topics without scores are excluded. However, topics in learning curriculum are highly related to each other and therefore, inability to understand a certain topic may also be caused by inability to understand related topics rather than the topic per se. Thus, a selection system that also considers related topics of teaching materials is required.

Moreover, the conventional technique related to the above method 2) enables a selection of knowledge suitable for questions by use of a mathematical programming approach. When the mathematical programming approach of the above method 2), i.e., genetic algorithm, is used as to find a solution, an enormous amount of computational effort is required. In the conventional technique, the genetic algorithm is used for preparing one set of test questions. The reason why the genetic algorithm is used in the conventional technique is because search for the solution is performed only once for all students. Meanwhile, personalized teaching material selection must be performed for each of the students. Thus, the search for the solution is required to be repeated for the number of times proportional to the number of the students. Consequently, the use of the genetic algorithm is not appropriate for selecting teaching materials for each of the students within some realistic time.

### BRIEF SUMMARY OF THE INVENTION

In consideration of the foregoing problems, it is an object of the present invention to provide a method and a device for selecting teaching materials most suitable for an examinee.

As a first aspect of the present invention, the following solving means is provided. There is provided a teaching material selection method for selecting a teaching material on the basis of learning assessment data on an examinee, the method allowing a computer to execute the steps of: calculating achievement of the examinee in an academic skill area on the basis of the learning assessment data and a difficulty level of the academic skill area; calculating importance of the academic skill area on the basis of an academic skill area interrelationship structure indicating an interrelationship between the achievement and the academic skill area; calculating a value of a teaching material on the basis of the importance; and selecting teaching materials on the basis of the values of the teaching materials.

According to a second aspect of the present invention, in the step of calculating the achievement, the academic skill area corresponding to a least common ancestor (LCA) is extracted from the academic skill areas with unknown achievement.

According to a third aspect of the present invention, in the step of calculating the importance, a transition between topics is defined and the computer calculates importance on the basis of the definition and the achievement.

According to another aspect, in the step of calculating the importance, a transition probability is set for the transition between topics.

Moreover, according to yet another aspect of the present invention, a computer program executed by the computer or a teaching material selection device having the computer program installed therein can also be provided.

Here, the “learning assessment data” means data on learning by the examinee such as scores of the examinees, learning time, whether or not the examinee attends a particular class and so on. The “academic skill areas (topics)” mean learning items in learning curriculums that also vary by grades and subjects. The “learning curriculum” means a sequence of educational contents established as a course in which students or schoolchildren learn. The “academic skill area interrelationship structure” means a dependence relationship between the topics and is expressed by a directed acyclic graph (hereinafter referred to as a DAG). The “LCA” (Least Common Ancestor) means a common ancestor closest to a set of (parent) nodes in DAG. In this aspect, the LCA means the closest common topic to a set of topics with low achievement and it is also called a basic topic. The “predetermined value” means average achievement, a preset threshold and the like.

The present invention has the following advantages.

First, the importance is calculated based on the achievement on the topic obtained from the learning assessment data on the examinee and the topic interrelationship structure. Thereafter, the value of the teaching material is calculated based on the importance, and a combination of teaching materials is obtained by use of the value of the teaching material. Thus, results can be obtained faster than the conventional techniques.

Secondly, the use of the LCA in the topic interrelationship structure enables the extraction of important and basic topics whose achievement values are not available from examinees scores.

Third, in the step of calculating the importance, by defining and using the transition between topics, all the topics required for selection of the teaching materials can be taken into consideration. Fourth, the setting of transition probability for the transition between topics makes it possible to obtain more accurate evaluation of importance.

### BRIEF DESCRIPTION OF THE SEVERAL VIEWS OF THE DRAWINGS

For a more complete understanding of the present invention and the advantage thereof, reference is now made to the following description taken in conjunction with the accompanying drawing.

FIG. 1 shows a functional configuration of a teaching material selection device according to an embodiment of the present invention.

FIG. 2 schematically shows processes performed by the teaching material selection device according to the embodiment of the present invention.

FIG. 3 shows a flow of processing performed by an achievement processing part.

FIG. 4 shows a topic interrelationship structure of project management training.

FIG. 5 shows only the structure by simplifying FIG. 4.

FIG. 6 shows topic interrelationship structures before and after extraction of topics with low achievement in S38 and a basic topic in the structure related to the topics with low achievement, which is extracted by processing in S41.

FIG. 7 shows an example of defining “transition between topics” in a simple F-DAGs.

FIG. 8 shows a flow of processing performed by an importance processing part.

FIG. 9 shows a flow of processing performed by a teaching material value processing part.

FIG. 10 shows a flow of processing performed by a teaching material selection processing part.

FIG. 11 shows topic graph examples with high importance.

FIG. 12 is a table showing results in the case where the topic graphs are straight lines (the graphs A to E in FIG. 11).

FIG. 13 is a table showing results in the case where each of the topic graphs has a comb shape (the graphs F to K in FIG. 11).

FIG. 14 is a table showing results in the case where each of the topic graphs is a combination of a line and a comb shape (the graphs L and M in FIG. 11).

FIG. 15 shows connections among results of an academic ability test, 6th grade math topic dependence and a 6th grade math teaching material DB in a concrete example of use of the present invention.

FIG. 16 shows a hardware configuration of the teaching material selection device.

### DETAILED DESCRIPTION OF THE INVENTION

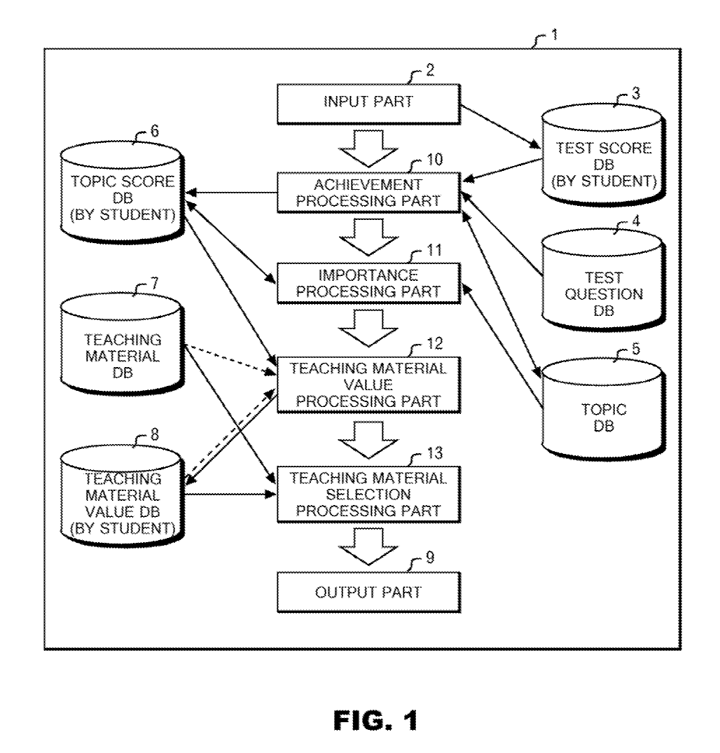

With reference to the drawings, an embodiment of the present invention will be described below. FIG. 1 shows a functional configuration of a teaching material selection device according to an embodiment of the present invention. The solid arrows indicate flows of data required at least in this embodiment, and the dotted arrows indicate flows of data used according to circumstances.

For simplicity, each of databases will be hereinafter described as a DB. A teaching material selection device 1 of this embodiment includes: a test score DB 3 which holds students info and their scores; a test question DB 4 which holds information about test questions; a topic DB 5 which holds difficulty levels of topics; a topic score DB 6 which holds association between the student and his/her achievement on each topic as well as the importance of each topic; a teaching material DB 7 which holds difficulty levels of teaching materials; and a teaching material value DB 8 which holds values of the teaching materials. The test score DB 3 is an example of learning assessment data storage means for storing each examinee's learning assessment data. Similarly, the test question DB 4 is an example of question information storage means for storing information about questions used in an examination. The topic DB 5 is an example of academic skill area interrelationship structure storage means for storing information about an academic skill area interrelationship structure. The topic score DB 6 is an example of importance storage means for storing association between the examinee and his/her achievement on the topic as well as importance of the topic. The teaching material DB 7 is an example of teaching material storage means for storing teaching material information in advance. The teaching material value DB 8 is an example of teaching material value storage means for storing association between the examinee and the value of the teaching material. Note that each of the storage means is not limited to the DB on a hard disk but may be an external storage unit such as a memory, a magnetic tape and a flexible disk (FD).

Moreover, the teaching material selection device 1 also includes: an achievement processing part 10 which calculates achievement of the student on each topic; an importance processing part 11 which calculates importance of the topic on the basis of the achievement; a teaching material value processing part 12 which calculates the value of the teaching material on the basis of the importance; and a teaching material selection processing part 13 which selects teaching materials most suitable for the student. The teaching material selection device 1 further includes: an input part 2 which inputs data; and an output part 9 which outputs data. Note that, although the teaching material selection device 1 is configured as one device in this embodiment, the device can also be built from multiple devices by separating the DBs and the processing parts. Moreover, the teaching material selection device can also have a server/client configuration via a network.

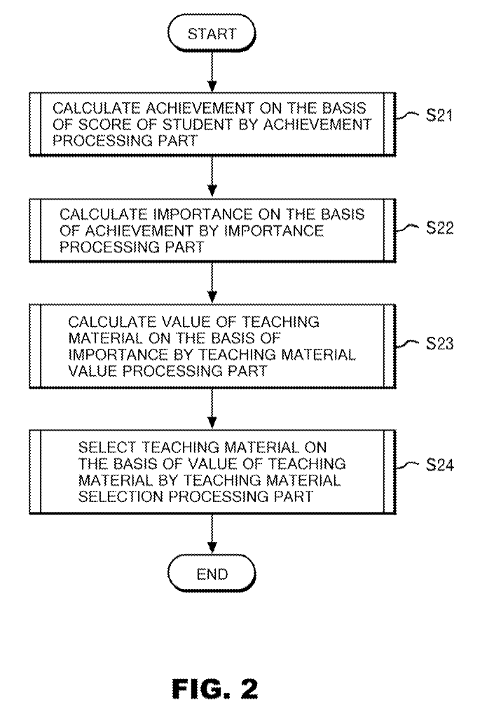

Next, description will be given of processes performed by the teaching material selection device 1, together with detailed functions of the respective DBs and functional parts described above. FIG. 2 schematically shows processes performed by the teaching material selection device of this embodiment. The teaching material selection device mainly performs the following four processes as shown in FIG. 2. Specifically, the four processes include: an achievement process (S21) performed by the achievement processing part 10 to calculate achievement on the basis of the student's score; an importance process (S22) performed by the importance processing part 11 to calculate the importance of the topic on the basis of the achievement; a teaching material value process (S23) performed by the teaching material value processing part 12 to calculate the value of the teaching material on the basis of the importance; and a teaching material selection process (S24) performed by the teaching material selection processing part 13 to select a teaching material most suitable for the student on the basis of the value of the teaching material. The four processes are executed in the above order.

The functions of the respective DBs and required minimum data items will be described below.

[Test Score DB 3]

The test score DB 3 holds test scores and is configured for each student. The DB holds the following data items.

ID: test question ID

Score: student's score

[Test Question DB 4]

The test question DB 4 shows a relationship between test questions and topics and is used for calculating achievement of the student on each topic on the basis of a result of the student's rating in each of the test questions. The DB holds the following data items.

ID: test question ID

Level: difficulty level of test question

Topics: list of related topics

Avg. Score: average score of all students

[Topic DB 5]

The topic DB 5 holds a topic interrelationship structure (presuppositions, subsequent conditions and the like) and is used for calculating the importance of the topic. The DB holds the following data items.

ID: topic ID

Level: difficulty level of topic

Related Topics: parents (presupposed topics), children (subsequent topics) and list of other related topics (collection of topics for which a parent-child relationship cannot be easily determined)

Avg. Score: average achievement of all students

[Topic Score DB 6]

The topic score DB 6 holds achievement on each topic as well as importance of each topic and is configured for each student. The DB holds the following data items.

ID: topic ID

Score: achievement on topic

Relevancy: importance of topic

[Teaching Material DB 7]

The teaching material DB 7 holds association between teaching materials and topics. The DB holds the following data items.

ID: teaching material ID

Level: difficulty level of teaching material

Hours: time required to study the teaching materials

Topics: list of covered topics

[Teaching Material Value DB 8]

The teaching material value DB 8 holds information on the value of the teaching material and the like and is configured for each student. The DB holds the following data items.

ID: teaching material ID

Number of Use: number of times the teaching material is selected in the past

Value: value of teaching material

<Achievement Processing Part>

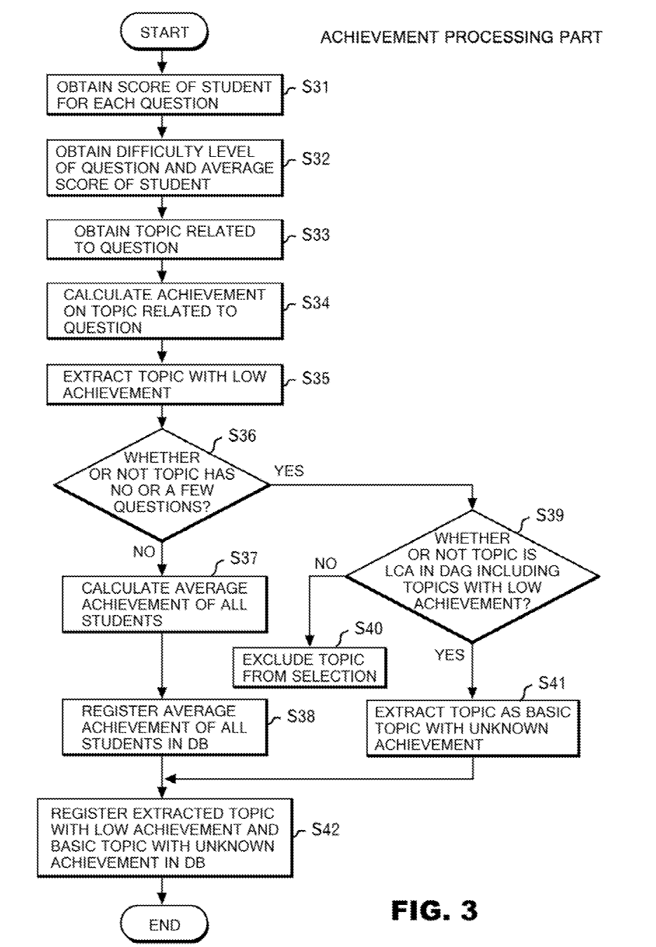

The individual processes for selecting a teaching material for a student by use of the DBs described above will be described. FIG. 3 shows a flow of processing performed by the achievement processing part. First, a test rating stores a score for each question in the test score DB 3 by use of the input part 2 such as a keyboard, a mouse and a digital pen. The score of the student for each question is obtained from the test score DB 3 (S31). Thereafter, a difficulty level of the question obtained in S31 and an average score of the student are obtained from the test question DB 4 (S32). Subsequently, topics related to the question are obtained from the test question DB 4 (S33). Based on the score and the difficulty level of the question, achievement on the topics related to the question, which are obtained in S33, is calculated (S34). Thereafter, only the topic with low achievement is extracted (S35). Subsequently, for all the topics obtained in S33, it is determined whether or not each of the topics is one on which there are no or a few test questions (S36). If the topic is the one on which there are test questions or not a few test questions, average achievement of all the students is calculated (S37) and the average achievement is registered in the topic DB 5 (S38). On the other hand, if the topic is the one on which there are no or a few test questions, it is determined whether or not the topic is an LCA in a DAG formed of the topics with low achievement (S39). The DAG will be described in detail later. If the topic is not the LCA in the DAG formed of the topics with low achievement, the topic is excluded from selection (S40). On the other hand, if the topic is the LCA in the DAG formed of the topics with low achievement, the topic is extracted as a basic topic with unknown achievement (S41). The topic with low achievement and the basic topic with unknown achievement, both of which are extracted as described above, are registered in the topic DB 5 (S42). Here, the low achievement means, for example, the case where the achievement is lower than the average achievement or a preset threshold.

The achievement process described above makes it possible to execute the following operations and the like. Specifically, when the student answers a difficult question correctly, achievement on topics related to the question is increased significantly. On the contrary, when the student gets an easy test question wrong, achievement on topics related to the question is reduced significantly. Moreover, the same process makes it possible to classify the topics used in the test into four groups in terms of achievement as compared with the average achievement of all the students: namely, high achievement (good), low achievement (bad), average achievement (average) and unknown achievement (unknown). The calculation of the average achievement of all the students also enables objective evaluation of the difficulty levels of the topics. Thus, the difficulty levels in the topic DB 5 can also be changed.

Here, the DAG means a directed graph without closed path. The directed graph means a graph including a group of several points and a group of arrows, each connecting two different points. The closed path means a path that repeatedly includes the same point.

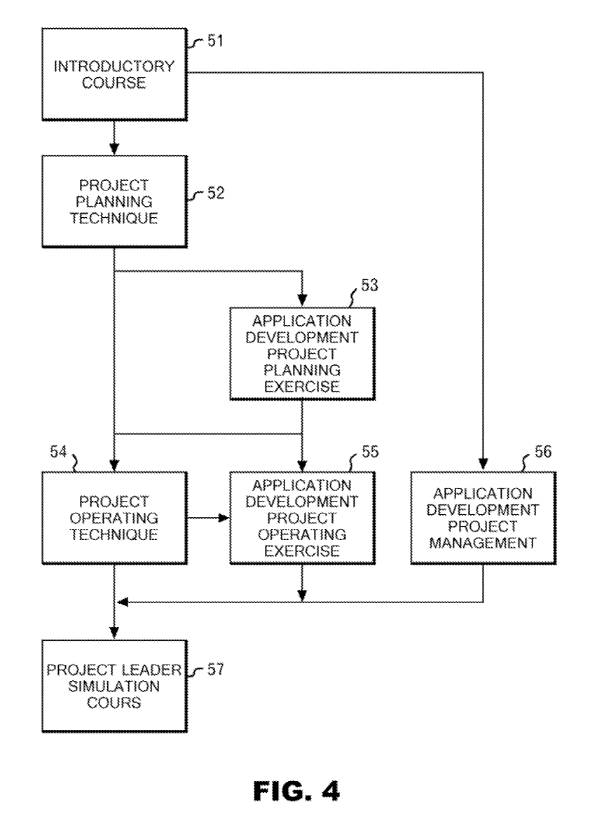

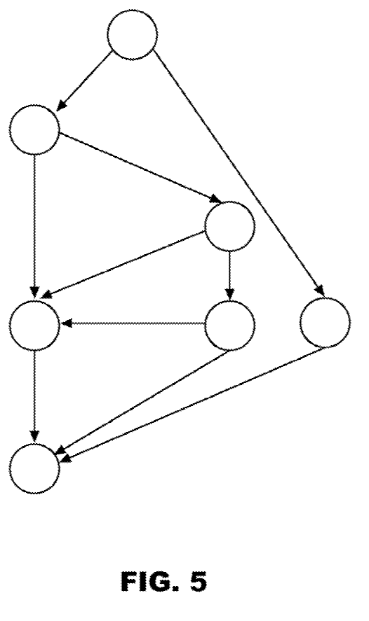

The reason why the topic interrelationship structure is expressed by the DAG in the embodiment of the present invention will be described. The topic interrelationship structure is given based on knowledge of a teacher or a curriculum configuration and is basically expressed by the DAG. This is because topics of many curriculums (or courses) are announced in a predetermined order and the topics form a DAG in that order. FIG. 4 shows a topic interrelationship structure of a certain project management training as an example. Respective courses surrounded by squares are topics of the project management training and the arrows indicate an order of taking the courses. FIG. 5 shows a simplified version of FIG. 4, in which a framework of the topic interrelationship structure is defined by replacing the courses shown in FIG. 4 by blank circles. With reference to FIGS. 4 and 5, the project management training can be expressed by a group of several topics and by arrows, each connecting two different topics. Moreover, since there is no path that repeatedly includes the same topic, it can be said that a DAG is formed. A parent topic of a project planning technique 52 and an application development project management 56 is an introductory course 51. Moreover, child topics of the project planning technique 52 are an application development project planning exercise 53 and a project operating technique 54. Furthermore, parent topics of a project leader simulation course 57 are the project operating technique 54, an application development project operating exercise 55 and the application development project management 56. As described above, each topic can have more than one parent topic. Since the DAG is a directed graph, the topics are required to be connected to each other by the arrows. However, in the embodiment of the present invention, even if the arrows between the topics are unknown, directions can be fixed later based on an order of taking the courses by each student or their scores. Note that in the construction of an education system, the topic interrelationship structure is often expressed as the DAG as pointed out by Non-patent Document 2.

Thus, the assumption that the topic interrelationship structure of learning curriculums forms a DAG is a natural one. When the topic interrelationship structure of the learning curriculums does not constitute a DAG (such as when the direction of arrows is unknown), the topic interrelationship structure can be converted into the DAG by use of the achievement in the embodiment of the present invention.

The reason why the topics with low achievement are extracted from the structure diagram related to all the topics in S38 is because teaching materials to be selected are related to the topics with low achievement. Since the topic interrelationship structure diagram is a connected DAGs, the extracted topics are generally a group of directed acyclic graphs (hereinafter referred to as an F-DAGs: Forest of DAGs). In S41, a basic topic of the F-DAGs of the topics with low achievement is extracted. Since the topics have an associated structure, low achievement on a certain topic may be caused by low achievement of related topics. Particularly, in the learning curriculums, the low achievement is often caused by that of the basic topic. Therefore, considering the basic topic in the selection system is important. Thus, the basic topic of the F-DAGs of the topics with low achievement is extracted together with all the topics with low achievement. The extracted topics are used for calculation of importance described below. However, since the basic topic might be a topic having no or a few test questions, the following problems arise. First, achievement of a topic having no test questions is not calculated. Secondly, as to the topic having a few test questions, a variation in the number of questions connected to the topic leads to a variation in reliability of the topic. These two problems are to be handled by including the basic topics to the calculation of importance as roots of the F-DAGs of the topics with low achievement to estimate their importance.

The basic topic of a group of topics with low achievement can be found by performing a fast calculation using a conventional LCA finding algorithm. However, when the LCA is too far from known topics (or close to the root of DAG), a large number of topics may be selected. In this case, the maximum value as to how many topics can be tracked back on the DAG is set to limit the number of basic topics selected.

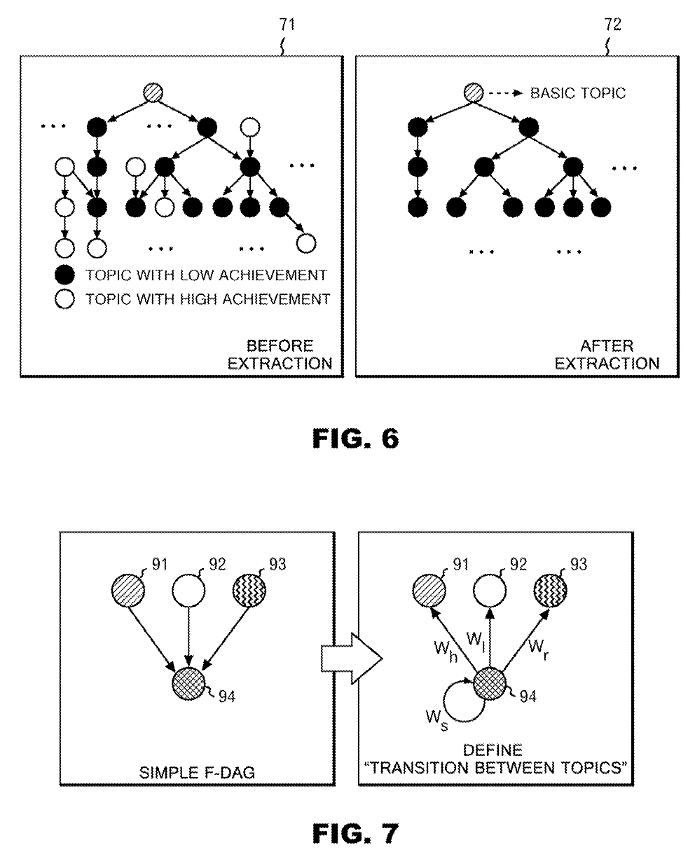

FIG. 6 shows the extraction of the topics in S38 and S41 described above. FIG. 6 shows topic interrelationship structures before and after the extraction of the topics with low achievement in S38, and the basic topic in the structure related to the topics with low achievement, which is extracted by the processing in S41. The topics with low achievement are indicated by black circles, topics with high achievement are indicated by white circles, and the basic topic is indicated by a shaded circle. A topic interrelationship structure 72 is obtained by extracting topics with low achievement by the processing in S38 and by extracting a basic topic with unknown achievement by the processing in S41 from a topic interrelationship structure 71 after calculation of achievement. Note that, as described above, the topic interrelationship structure after the extraction of the topics is set to be an F-DAGs. In FIG. 6, the basic topic is positioned on the top of the F-DAGs.

<Importance Processing Part>

After the process by the achievement processing part 10 is finished, calculation of importance of the topics is performed by the importance processing part 11 in consideration of the topic interrelationship structure. The importance calculation has two steps: a step of obtaining importance from achievement; and a step of obtaining importance in consideration of the DAG from the obtained importance. The importance obtained from the achievement will be hereinafter referred to as the initial importance. For obtaining the importance in consideration of the DAG from the initial importance, the following principles are used.

(Principle 1)

A parent of a topic with high importance is important. This is a principle based on the fact that, as to a topic with low achievement, not only a review of the topic itself but also a review of its parents (bases) of the topic is important to the student. Summingly, low achievement on a certain topic is assumed to be caused by a lack of understanding about the topic itself or the parent topics thereof.

(Principle 2)

A topic having many child topics with high importance is important. This means when the achievement on application topics is low, the importance to review the basic topic common to those application topics is increased. In addition to the above principles, a “transition between topics” is defined in the F-DAGs of the topics with low achievement that are extracted by the achievement processing part.

The “transition between topics” is defined by reversing the directions of the arrows in the F-DAGs of the topics with low achievement, which is extracted by the achievement processing part 10, and by adding a self transition, i.e., the transition to the same topic. The “transition between topics” will be concretely described with reference to FIG. 7. FIG. 7 shows an example of defining the “transition between topics” in a simple F-DAGs. The left part of FIG. 7 shows an F-DAGs of topics with low achievement, in other words, with high initial importance, which are extracted by the achievement processing part 10. Moreover, the right part of FIG. 7 shows the resulting transition diagram obtained by defining a “transition between topics” of the left part of FIG. 7. The F-DAGs shown in the left part of FIG. 7 has a structure in which a child topic of topics 91 to 93 is topic 94. When the “transition between topics” is applied to the F-DAGs shown in the left part of FIG. 7, the arrows from the topics 91 to 93 to the topic 94 are reversed, respectively, and an arrow indicating a transition to the topic 94 itself is added, resulting in the right part of FIG. 7. In addition to the above principles, after defining “transition between topics” the importance of topics is determined based on (1) initial importance of the original topic, (2) the number of topics in the original transition, (3) the length of the topic chain and (4) achievement on the topic itself. The method for determining importance described above is similar to a PageRank method.

PAGERANK is the output of an algorithm for measuring importance of a web page on the World Wide Web and can be considered as measuring the importance of the web page. The PageRank method is a method for determining PAGERANK in the following manner. Links from page A to page B are regarded as supporting votes from page A to page B, and the importance of page B depends on the number and quality of the votes it receives. Specifically, the importance of the page is determined by (1) the importance and (2) the number of pages linking to it.

Accordingly, the topic importance determination method and the PageRank method can be said to be similar since the two methods have the common the principles in calculating the importance. However, the topic importance determination method in this embodiment is different from the PageRank method in the following two points: (3) the longer the chain of the topics, the higher the importance of the root of the chain; and (4) the importance of the self topic is also used. The reason why (4) the importance of the self topic is used for determination of the importance of the topic is because factors that cause a lack of understanding in the learning curriculums include not only related topics but also the topic itself.

Next, with reference to FIG. 7, description will be given on the transition probability in the “transition between topics” used for the importance calculation. The transition probability means a probability of occurrence of each of transitions from a topic to another one. For a transition probability in the PageRank method, a value determined for each topic, for example, importance is not taken into consideration. That is, all the transitions have the same probability. Meanwhile, in the embodiment of the present invention, the transition probability is determined by taking into consideration the achievement value of each topic. With reference to FIG. 7, description will be given of conditions for determining the transition probability when the achievement is taken into consideration.

In FIG. 7, a probability of each of four transitions from the topic 94 to the topics 91 to 94 is the transition probability. Let the transition probability from the topic 94 to the topic 94 be Wₛ, the transition probability from the topic 94 to the topic 91 be Wₕ, the transition probability from the topic 94 to the topic 92 be Wₗ, and the transition probability from the topic 94 to the topic 93 be Wᵣ. The weights of the transition probabilities Wₛ, Wₕ, Wₗ and Wᵣ are set as described below. Note that the sum of the transition probabilities Wₛ, Wₕ, Wₗ and Wᵣ is set to 1.
(1) When the topic is the basic topic, transition destinations are set to be all the topics and weights thereof are set the same. Moreover, when the topic is the root in the DAG, transition destinations are set to be the topic itself and all the other topics.

For cases other than (1),
(2) For the topic with low achievement, the transition probability Wₛ to itself is set higher.
(3) In the case where achievement of the topic at the transition destination is lower than that of itself, the transition probability Wₕ to that topic is set low.
(4) In the case where achievement of the topic at the transition destination is higher than that of itself, the transition probability Wᵣ to that topic is set high.
(5) In the case where the topic at the transition destination is the basic topic, the transition probability Wᵣ to that topic is set low.

By the principles, the “transition between topics” and the determination of the transition probability under the conditions described above, the importance of the topics can be obtained with high accuracy compared with the case of using the PageRank method. This point will be described later in Example 1.

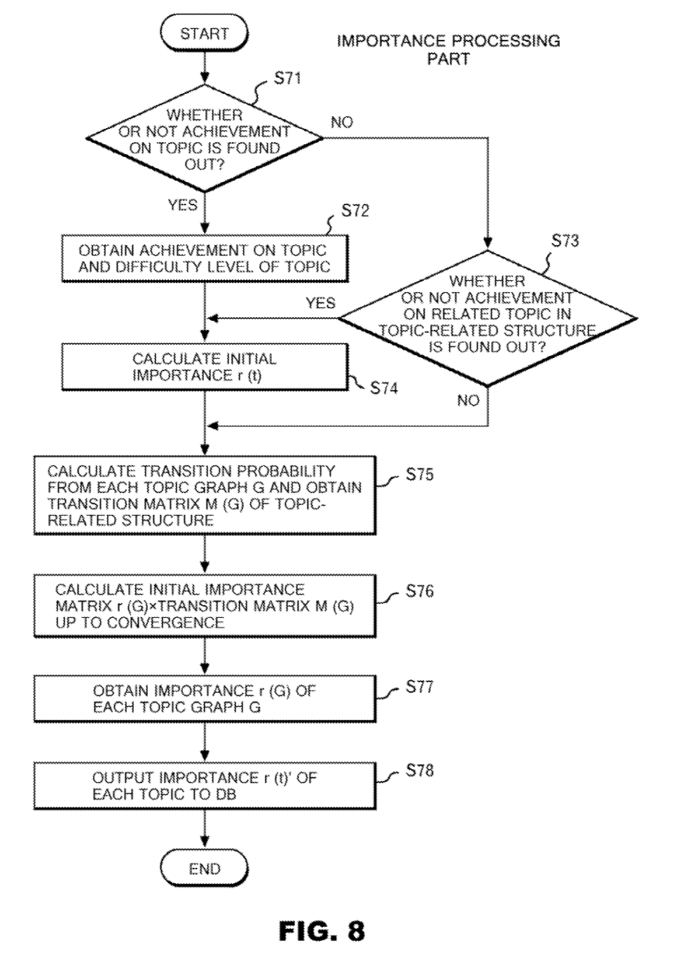

FIG. 8 shows a flow of processing performed by the importance processing part. It is determined whether or not achievement on each of the topics extracted by the achievement processing part is already known (S71). As to such topics, the achievement and a difficulty levels are obtained (S72) and initial importance r (t) is calculated (S74). The initial importance r (t) does not reflect the topic interrelationship structure. Meanwhile, if the achievement on the topic is not known, it is determined whether or not the achievement on its related topics in the topic interrelationship structure is known (S73). In such a case, initial importance r (t) of the related topics is calculated (S74). Otherwise, the initial importance r (t) is set to zero. Next, transition probabilities are calculated according to the previous explanation for respective topic graphs G. Thus, a transition matrix M (G) is obtained (S75). Here, assuming that the initial importance r (t) of each topic t obtained in S74 is a column vector, an importance vector r (G) of the topic graph G is expressed by the following equation (1). The importance vector r (G) is initialized in proportion to the achievement and difficulty level of the topic.

[Equation 1]

r(G)=(r(t1), r(t2), r(t3), . . . , r(tN)) (1)

For the importance vector r (G) and the transition matrix M (G) described above, calculations of the following equations (2) and (3) are repeated until r (G) is converged (S76).

[Equation 2]

r(G)′=M(G)r(G) (2)

[Equation 3]

r(G)=r(G)′ (3)

As a result, the converged topic importance r (G) is obtained (S77), and the importance r (t)′ of each topic is outputted to the topic score DB 6 (S78).

The topic importance r (G) obtained by the above calculations reflects the topic interrelationship structure. In the experiment, by setting the transition probabilities such that Wₛ:Wₕ:Wₗ:Wᵣ=2:1:1:2, the topic importance r (G) can be obtained by performing about 10 repetitions of Equations (2) and (3).

<Teaching Material Value Processing Part>

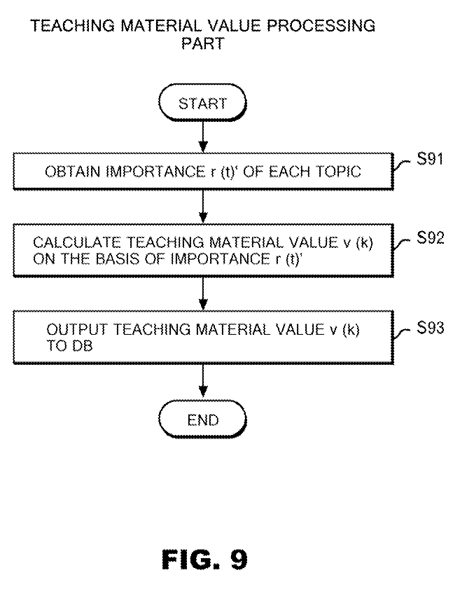

FIG. 9 shows a flow of processing performed by the teaching material value processing part. The teaching material value processing part 12 obtains, from the topic score DB 6, the importance r (t)′ of each topic obtained by the importance processing part (S91). Thereafter, based on the difficulty level of the topic held in the topic DB 5, the difficulty level of the teaching material held in the teaching material DB 7, the number of times the teaching material is selected in the past, which is held in the teaching material value DB 8, and the like, a value (a normalized value) v (k) of a teaching material k is calculated (S92). The calculated value v (k) is outputted to the teaching material value DB 8 (S93).

The following equations (4) and (5) are calculation examples of v (k). The equation (4) is the case where only the importance determines the value of the teaching material. The equation (5) is the case where the value is determined from the importance combined with other factors calculated from other method, for example, the difficulty level of the topic. Note that, if the teaching material covers multiple topics, its value can also be obtained by adding importances of those covered topics.

[Equation 4]

v(k)=r(t)′ (4)

[Equation 5]

v(k)=a×r(t)′+b×s(t) (5)

<Teaching Material Selection Processing Part>

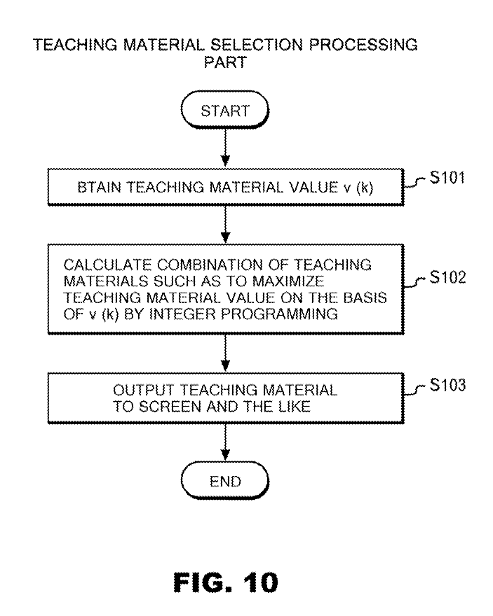

FIG. 10 shows a flow of processing performed by the teaching material selection processing part. The teaching material selection processing part 13 obtains, from the teaching material value DB 8, the value of the teaching material outputted by the teaching material value processing part (S101). Thereafter, a combination of teaching materials maximizing the value of the teaching material is obtained by integer programming (S102). The combination of the teaching materials obtained in S102 is outputted to the teacher by use of a display or a printer through the output part 9 (S103). For the integer programming in this embodiment, either the following Knapsack or set-covering integer formulation is used.

The Knapsack integer programming problem is as follows. Specifically, given one knapsack having a capacity C and n pieces of items (each having a value pi and a capacity ci), some of the items are packed in the knapsack within a range not exceeding the capacity C of the knapsack and the sum of the values of the items packed in the knapsack is maximized. The set covering problem is as follows. Specifically, given a set U and its subset groups S, . . . , and Sm, the minimum number of subsets are selected from the subset groups so as to cover all elements of U. Here, the sum of sets S, . . . , and Sm is assumed to be equal to U. The Knapsack integer programming problem and the set covering problem are NP-hard problems. Although it is difficult to obtain a correct solution, there is a fast approximation algorithm. Thus, the solving method by either the Knapsack or set-covering integer programming formulation makes it possible to obtain the solution faster than the conventional case. Formula (6) is a Knapsack formulation example for maximizing the value of the teaching material. Formula (7) is a formulation example for maximizing the value of the teaching material by taking into consideration the number of covered topics. Here, T is a set of topics (with high importance), K is a set of teaching materials related to the topic set T, c(k) is a cost of the teaching material k (such as learning time), x(k) is a selection variable of the teaching material k, t(i) is a cover variable of a topic i (a variable indicating whether or not the topic is covered by the selected teaching material), K(i) is a set of teaching materials covering the topic i, and c is an upper limit of the cost.

(1) An example of Knapsack formulation for maximizing the value of the teaching material

$$\begin{matrix}[ Formula 6 ] & \\ \begin{matrix}\begin{matrix}\begin{matrix}Max {\sum }_{k ∈ K}^{ } x ( k ) \cdot v ( k ) \\ Subject to {\sum }_{k ∈ K}^{ } x ( k ) \cdot c ( k ) \leq c ,\end{matrix} \\ {\sum }_{k ∈ K ( i )}^{ } x ( k ) ≧ t ( i ) , for each i\end{matrix} \\ x ( k ) , t ( i ) ∈ \{ 0 , 1 \}\end{matrix} \} & ( 6 )\end{matrix}$$

(2) An example of formulation for maximizing the value of the teaching material by taking into consideration the number of topics to be covered

$$\begin{matrix}[ Formula 7 ] & \\ \begin{matrix}\begin{matrix}\begin{matrix}Max {\sum }_{k ∈ K}^{ } x ( k ) \cdot v ( k ) + α {\sum }_{i ∈ T}^{ } t ( i ) \\ Subject to {\sum }_{k ∈ K}^{ } x ( k ) \cdot c ( k ) \leq c ,\end{matrix} \\ {\sum }_{k ∈ K ( i )}^{ } x ( k ) ≧ t ( i ) , for each i\end{matrix} \\ x ( k ) , t ( i ) ∈ \{ 0 , 1 \}\end{matrix} \} & ( 7 )\end{matrix}$$

α is a positive constant set by taking into consideration the weight of the number of covered topics. α=0 corresponds to Knapsack maximization of the teaching material, and the case where α is large corresponds to maximization on the number of topics to be covered.

### EXAMPLE 1

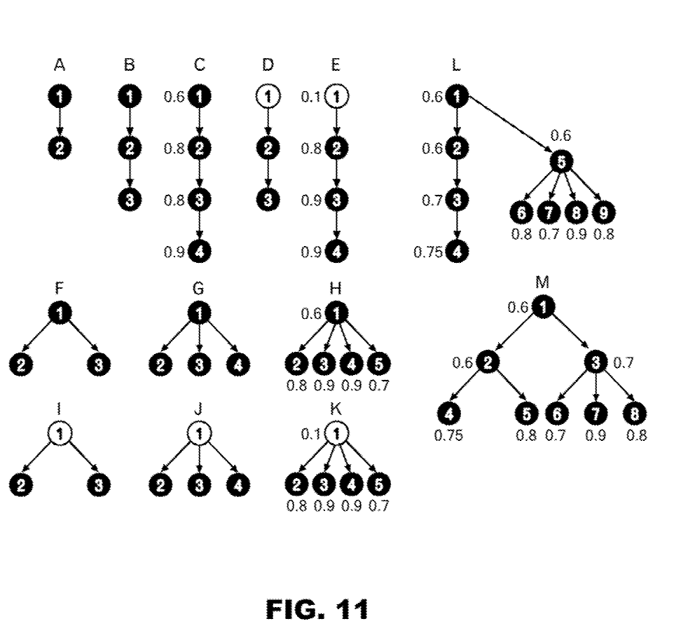

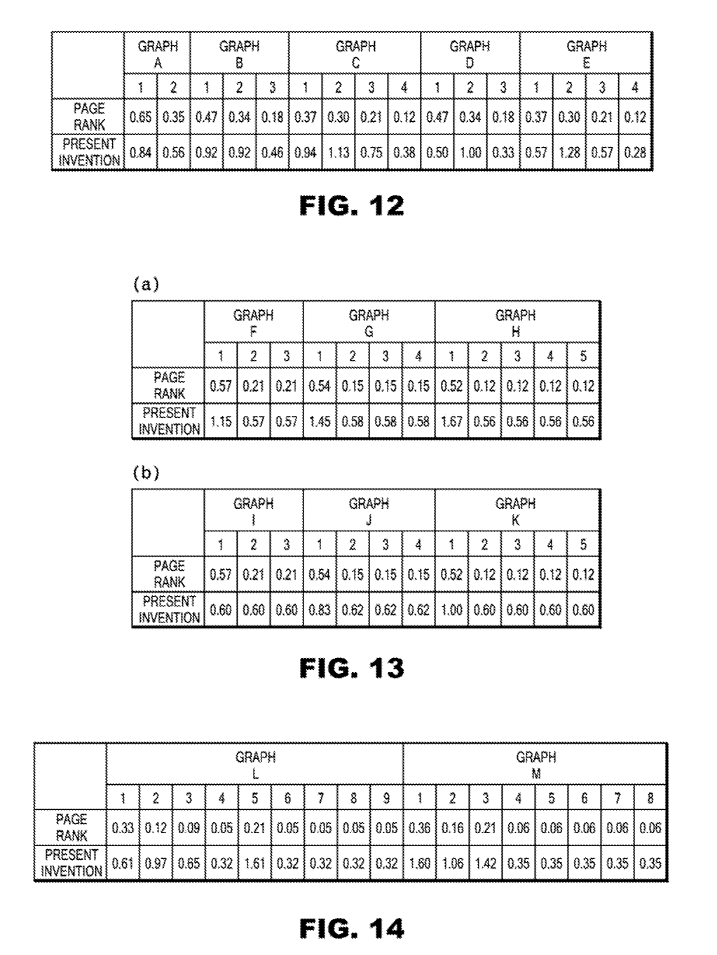

Next, description will be given on results of an experiment on ranking performance of the topics in descending order of importance (hereinafter referred to as “topic rank”) in the case where the principles of the “transition between topics” based on the topic interrelationship structure and the transition probabilities according to the embodiment of the present invention are used. FIG. 11 shows topic graph examples with high importance. Graphs A to M shown in FIG. 11 are simple topic graphs. Each of the numbers described to the left of or below the topics in the graphs indicates the initial importance of the topic. The graphs A and B have the same initial importance as that of the topic having the same number in the graph C. Similarly, those of the graph D corresponds to those of the graph E, those of the graphs F and G correspond to those of the graph H, those of the graphs I and J correspond to those of the graph K. FIGS. 12 to 14 show results of importance of each of the topics when the PageRank and the topic rank method are applied to the graphs A to M.

FIG. 12 shows results in the case where the topic graphs are straight lines (the graphs A to E in FIG. 11) in a table of importance for each topic. As to the graphs A to C, the longer the chain of the topics, the higher the importance of the basic topic (root of the graph) in the chain gets. This is in order to verify that the rank of the basic topic gets higher. Moreover, the graphs D and E have basic shapes similar to those of the graphs B and C. This is in order to verify the case where there is no data on achievement concerning the basic topics (or data is not sufficient for determination).

The results shown in FIG. 12 show that, in this embodiment, the longer the chain of the topics with high importance, the higher the importance and rank of the basic topic in the chain get. Moreover, in this embodiment, it is also found out that the importance is lower when there is no data on the importance of the basic topic in the chain than when there is the data on the importance besides the fact that the properties described above are achieved. Meanwhile, as is clear from FIG. 12, such characteristics cannot be obtained when the PageRank method is adopted. However, unlike the case of the PageRank method, the result of the experiment according to this embodiment does not reach 1 even if the importances of all the topics in the graph are added up. This is because the result is the value calculated from the initial importance of the topic shown in FIG. 10.

FIG. 13 shows results in the case where each of the topic graphs has a comb shape (the graphs F to K in FIG. 11) in a table of importance for each topic. The graphs F to H are for verifying that the more the child topics with high importance, the higher the importance and rank of the basic topic get. The graphs I to K have basic shapes similar to those of the graphs F to K. This is in order to verify the case where there is no data on achievement of the basic topics (or data is not sufficient for determination).

The results shown in FIG. 13 show that, in this embodiment, the more the child topics with high importance, the higher the importance and rank of its parent get. The obtained rank is the same even when the PageRank method is adopted. However, in the PageRank method, the topic having many child topics is ranked low and the same result is obtained regardless the importance of the basic topic itself. Thus, the PageRank method as it is cannot achieve the objective of this embodiment that is intended to obtain appropriate importance even when the basic topic has no data on importance.

FIG. 14 shows results in the case where each of the topic graphs is a combination of a line and a comb shape (the graphs L and M in FIG. 11) in a table of importance for each topic. The results shown in FIG. 14 show that, in this embodiment, the topics with high importance are correctly ranked even if the line and the comb shapes are combined. To be more specific, in the graph L, Topic 1 having a long chain is ranked first. In the graph M, Topic 1 having seven child topics is ranked first, Topic 3 having three child topics is ranked second, and Topic 2 having two child topics is ranked third. Specifically, a parent topic having a long chain and a parent topic having many child topics are ranked high.

As to the topic rank in the graph L (and the graph M), the PageRank method and this embodiment show the same results. However, the ranking differs when the graphs L and M are directly compared with each other. This embodiment is different from the PageRank method in the point that the setting of transition probabilities makes it possible to make a direct adjustment as to whether emphasis is placed on the basic topic having a long chain or on the basic topic having many child topics.

The topics in the learning curriculums have the following characteristics.

(1) the topic having a long chain of successor topics has higher importance.

(2) the topic having many child topics has higher importance.

(3) importance is required since the topic with unknown achievement might be relevant.

The previous results show the following. Specifically, the results obtained by taking into consideration the above three characteristics cannot be achieved by adopting the PageRank method as it is, but can be achieved by applying the principles of the “transition between topics” based on the topic interrelationship structure and the transition probabilities according to this embodiment.

### EXAMPLE 2

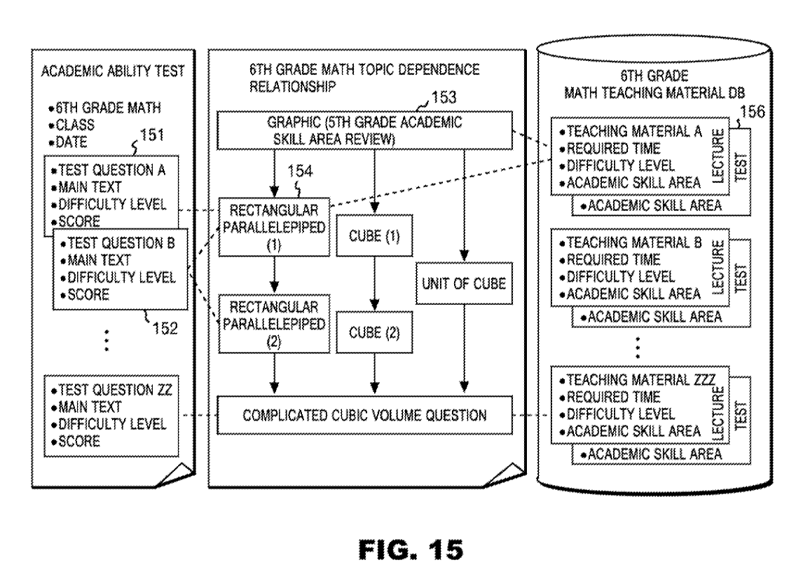

FIG. 15 shows connections among results of an academic ability test, 6^{th} grade math topic dependence and a 6^{th} grade math teaching material DB in a concrete example used by the present invention. The connections are indicated by dotted lines. Test questions are associated with topics included in a DAG. In FIG. 15, a test question A 151 is associated with a rectangular box (1) 154, and a test question B 152 is associated with both of the rectangular box (1) 154 and a rectangular box (2) 155. On the other hand, the rectangular box (1) 154 is associated with the test question A 151 and the test question B 152. Similarly, topics are associated with teaching materials. In FIG. 15, a graphic (5^{th} grade academic skill area review) 153 is associated with a teaching material A 156 and the rectangular box (1) 154 is associated with the teaching material A 156. The above results show that one-to-one correspondence is not necessarily achieved between the test questions and the topics as well as between the topics and the teaching materials, and that teaching materials for test and teaching materials for review are associated with each other through the topics.

It is also possible to combine this embodiment with teaching material selection by matching. In this case, an academic skill area for the teaching material selection by matching is set, difficulty levels of teaching materials are set for each academic skill area, and a list of teaching materials that meet the conditions is prepared. As an example of combining this embodiment with the teaching material selection by matching, the following method can be considered: a matching mode is set if the score is within top X% or bottom Y%, or this embodiment if otherwise.

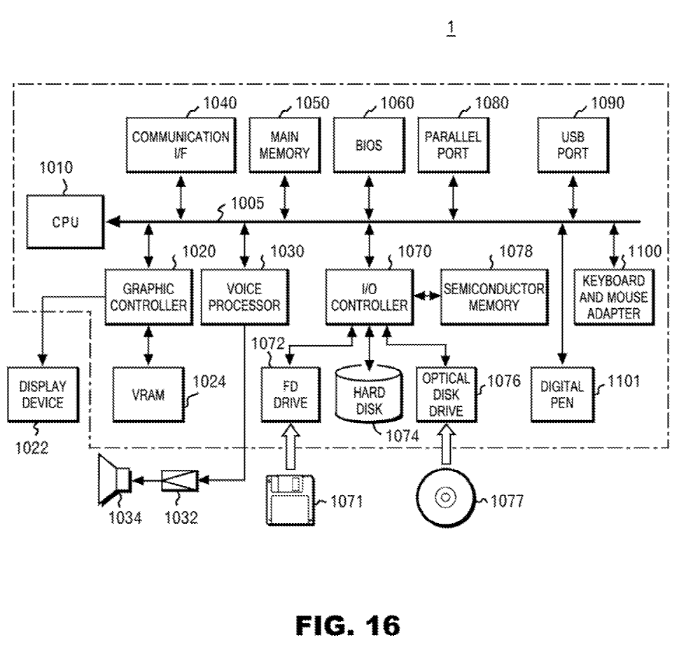

FIG. 16 shows a hardware configuration of the teaching material selection device 1 according to the embodiment of the present invention. A general configuration of an information processor typified by a computer will be described below. However, needless to say, in the case of a dedicated device or a built-in device, a required minimum configuration can be selected according to its environment.

The teaching material selection device 1 includes a CPU (Central Processing Unit) 1010, a bus line 1005, a communication I/F 1040, a main memory 1050, a BIOS (Basic Input Output System) 1060, a parallel port 1080, a USB port 1090, a graphic controller 1020, a VRAM 1024, a voice processor 1030, an I/O controller 1070 and input means such as a keyboard and a mouse adapter 1100 and a digital pen 1101. Moreover, storage means such as a flexible disk (FD) drive 1072, a hard disk 1074, an optical disk drive 1076 and a semiconductor memory 1078 can be connected to the I/O controller 1070. A display device 1022 is connected to the graphic controller 1020. Furthermore, as options, an amplifier circuit 1032 and a speaker 1034 are connected to the voice processor 1030.

The BIOS 1060 stores a boot program to be executed by the CPU 1010 when the teaching material selection device 1 is activated, a program dependent on the hardware of the teaching material selection device 1, and the like. The FD drive 1072 reads a program or data from a flexible disk 1071 and provides the program or data to the main memory 1050 or the hard disk 1074 through the I/O controller 1070.

As the optical disk drive 1076, for example, a DVD-ROM drive, a CD-ROM drive, a DVD-RAM drive and a CD-RAM drive can be used. In this case, it is required to use an optical disk 1077 corresponding to each of the drives. The optical disk drive 1076 can also read a program or data from the optical disk 1077 and provide the program or data to the main memory 1050 or the hard disk 1074 through the I/O controller 1070.

A computer program provided to the teaching material selection device 1 is stored in a recording medium such as the flexible disk 1071, the optical disk 1077 and a memory card and is provided by a user. This computer program is read from the recording medium through the I/O controller 1070 or downloaded through the communication I/F 1040. Thus, the computer program is installed on the teaching material selection device 1 and executed. Since operations that the computer program allows the teaching material selection device 1 to perform are the same as those performed by the device already described, description thereof will be omitted.

The computer program described above may be stored in an external storage medium. As the storage medium, a magneto-optical recording medium such as an MD and a tape medium can be used, besides the flexible disk 1071, the optical disk 1077 and the memory card. Moreover, a hard disk installed in a server system connected to a dedicated communication line or the Internet, or a storage unit such as an optical disk library may be used as the recording medium to provide the computer program to the teaching material selection device 1 through the communication line.

In the above example, the teaching material selection device 1 has been mainly described. Meanwhile, it is possible to achieve the functions of the teaching material selection device 1 described above by installing a program having the above functions on a computer. Therefore, the teaching material selection device 1 described as one embodiment of the present invention can also be achieved by a method and a computer program thereof.

As described above, the teaching material selection device 1 of the present invention can be achieved as hardware, software or a combination of hardware and software. As implementation of the present invention by the combination of hardware and software, implementation in a computer system having a predetermined program is cited as a typical example. In this case, the predetermined program is loaded into the computer system and executed to allow the computer system to execute the processes according to the present invention. This program includes a command group that can be expressed by an arbitrary language, code or description. Such a command group enables the system to directly execute a specific function or to execute the specific function after any one of or both of (1) conversion into another language, code or description and (2) duplication on another medium are performed. As a matter of course, the scope of the present invention includes not only such a program itself but also a program product including a medium having the program recorded thereon. The program for executing the functions of the present invention can be stored in an arbitrary computer-readable medium such as a flexible disk, an MO, a CD-ROM, a DVD, a hard disk device, a ROM, an MRAM and a RAM. The program can be downloaded from another computer system connected through a communication line or can be duplicated from another medium so as to be stored in the computer-readable medium. Moreover, the program can also be stored in a single or multiple recording media by compression or division into multiple parts.

Although the present invention has been described above according to the embodiment, the present invention is not limited to the embodiment described above. Moreover, the effects described in the embodiment of the present invention are merely listed as preferred effects achieved by the present invention. The effects of the present invention are not limited to those described in the embodiment or example of the present invention.

The present invention, advantageously provides a teaching material selection method which enables suitable teaching materials to be selected based on learning assessment data of an examinee in a short time and with high accuracy compared with the conventional methods, and also to provide a computer program and a teaching material selection device.

Although the preferred embodiment of the present invention has been described in detail, it should be understood that various changes, substitutions and scope of the inventions as defined by the appended claims.

That which is claimed is:

1. A teaching material selection method executed by a computer for selecting a teaching material on the basis of learning assessment data on an examinee, the method causing a computer to execute the steps of:
calculating achievement of the examinee in an academic skill area on the basis of the learning assessment data and the difficulty level of the academic skill area;
calculating importance of the academic skill area on the basis of an academic skill area interrelationship structure indicating interrelationship between the achievement and the academic skill area;
calculating the value of a teaching material on the basis of the importance; and
selecting teaching materials on the basis of the values of the teaching materials.

2. The method according to claim 1, wherein the step of calculating the achievement includes extracting the academic skill area corresponding to a least common ancestor (LCA) from academic skill areas with unknown achievement on the basis of the interrelationships structure of the academic skill area.

3. The method according to claim 1, wherein the step of calculating the achievement includes a step of extracting the academic skill area having the achievement lower than a predetermined value.

4. The method according to claim 1, wherein the step of calculating the importance includes a step of calculating importance by using an academic skill area with unknown achievement as a root in the academic skill area interrelationship structure.

5. The method according to claim 1, wherein, in the step of calculating the importance, a transition between academic skill areas is defined and importance is calculated based on the definition and the achievement.

6. The method according to claim 5, wherein, in the step of calculating the importance, a transition probability is set for the transition between academic skill areas.

7. The method according to claim 1, wherein, in the step of calculating the value of the teaching material, the value of the teaching material is calculated based on information on academic skill areas and information on teaching materials corresponding to the academic skill areas.

8. The method according to claim 1, wherein, in the step of selecting the teaching material, the most suitable combination of the teaching materials is obtained based on the value of the teaching material by use of integer programming.

9. A teaching material selection device for selecting a teaching material on the basis of learning assessment data on an examinee, comprising:
an achievement processing part which calculates achievement of the examinee in an academic skill area on the basis of the learning assessment data and a difficulty level of the academic skill area;
an importance processing part which calculates importance of the academic skill area on the basis of an academic skill area interrelationship structure indicating an interrelationship between the achievement and the academic skill area;
a teaching material value processing part which calculates the value of a teaching material on the basis of the importance; and
a teaching material selection processing part which performs calculation for selecting teaching materials on the basis of the values of the teaching materials.

10. The teaching material selection device according to claim 9, wherein the achievement processing part extracts the academic skill area corresponding to a least common ancestor (LCA) from academic skill areas with unknown achievement on the basis of the interrelationship structure of the academic skill area.

11. The teaching material selection device according to claim 9, wherein the achievement processing part includes:
learning assessment data storage means for storing association between the examinee and the learning assessment data;
question information storage means for storing information on questions used in an examination; and
academic skill area interrelationship structure storage means for storing information about the interrelationship structure of the academic skill area.

12. The teaching material selection device according to claim 9, wherein the importance processing part includes:
academic skill area interrelationship structure storage means shared with the achievement processing part; and
importance storage means for storing association between the examinee and the importance of each academic skill area.

13. The teaching material selection device according to claim 9, wherein the teaching material value processing part includes:
importance storage means shared with the importance processing part; and
teaching material storage means for storing teaching material information in advance.

14. The teaching material selection device according to claim 9, wherein the teaching material selection processing part includes teaching material value storage means for storing association between the examinee and the value of the teaching material.

15. A computer program product comprising tangible computer-readable medium embodying program code for selecting a teaching material on the basis of learning assessment data on an examinee, the program code causing a computer to:
calculate achievement of the examinee in an academic skill area on the basis of the learning assessment data and the difficulty level of the academic skill area;
calculate importance of the academic skill area on the basis of an academic skill area interrelationship structure indicating interrelationship between the achievement and the academic skill area;
calculate the value of a teaching material on the basis of the importance; and
select teaching materials on the basis of the values of the teaching materials.

16. The computer program according to claim 15, wherein the program code to calculate the achievement includes program code to extract the academic skill area corresponding to a least common ancestor (LCA) from academic skill areas with unknown achievement on the basis of the interrelationships structure of the academic skill area.

17. The computer program according to claim 15, wherein the program code to calculate the achievement includes program code to extract the academic skill area having the achievement lower than a predetermined value.

18. The computer program according to claim 15, wherein the program code to calculate the importance includes program code to calculate importance by using an academic skill area with unknown achievement as a root in the academic skill area interrelationship structure.

19. The computer program according to claim 15, wherein, in the program code to calculate the importance, a transition between academic skill areas is defined and importance is calculated based on the definition and the achievement.

20. The computer program according to claim 19, wherein, in the program code to calculate the importance, a transition probability is set for the transition between academic skill areas.
